(19) United States
(12) Patent Application Publication
(10) Pub. No.: US 2010/0330904 A1
(43) Pub. Date: Dec. 30, 2010

(54) METHOD, APPARATUS, AND COMPUTER PROGRAM PRODUCT FOR REFRESHING A CONFIGURATION OF A CONTACTLESS FRONTEND DEVICE

(75) Inventor: Keld Stougaard, Karlslunde (DK)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 12/494,508

(22) Filed: Jun. 30, 2009

(51) Int. Cl. H04B 5/00

(52) U.S. Cl. 455/41.1; 340/10.1

(57) ABSTRACT

An apparatus for reinitializing and activating a Single Wire Protocol (SWP) communication channel and refreshing or updating a configuration of a contactless frontend (CLF) device may include a processor and a memory storing executable computer program code that cause the apparatus to at least perform operations including determining whether one or more parameters associated with an application(s) are to be sent to a first device in order for the first device to execute the application. The computer program code may further cause the apparatus to determine whether a Single Wire Protocol (SWP) communication channel is active and may generate a command to activate the SWP communication channel in response to receipt of a first indication that the SWP communication channel is inactive or suspended. A corresponding method and computer program product are also provided.

### TECHNOLOGICAL FIELD

Embodiments of the present invention relate generally to mobile terminal technology and, more particularly, relate to a method, apparatus, and computer program product for providing a new mechanism for reinitializing and activating a Single Wire Protocol (SWP) interface or communication channel and for refreshing or updating a configuration of a contactless frontend device.

### BACKGROUND

The modem communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. One area in which there is a demand to increase ease of information transfer relates to the delivery of services to a user of a mobile terminal. The services may be in the form of a particular media or communication application desired by the user, such as a music player, a game player, an electronic book, short messages, email, content sharing, web browsing, etc. The services may also be in the form of interactive applications in which the user may respond to a network device in order to perform a task or achieve a goal. The services may be provided from a network server or other network device, or even from the mobile terminal such as, for example, a mobile telephone, a mobile television, a mobile gaming system, etc.

Some of these services may be stored on an Integrated Circuit Card (ICC) also referred to herein as a smart card such as for example, a Subscriber Identity Module (SIM) card, a Universal Integrated Circuit Card (UICC) or the like. The ICC may be removable from a terminal (e.g., mobile terminal such as a cellular telephone) and may be associated with a personal identification number (PIN) code uniquely identifying a user to a network operator and which typically allows the user to access the services or applications stored in a memory of the ICC. New services or updates to currently stored services may be provided to the ICC in a terminal by a network server, network device, etc. The network server or network device may send the ICC the updated service or new service over the air (OTA) wirelessly. Some of these updated or new services may be Near Field Communication (NFC) applications which may require exchange of data (e.g., radio frequency identification data (RFID)) with transponders or reader devices over short distances during execution of the applications. One such example of a NFC application is a public transportation payment application in which a user may purchase a fare for a train ride for example by placing the ICC in the terminal within an appropriate distance or range of a transponder operated by a public transportation system. In this regard, credit card information or the like of the user may be transmitted from the ICC to the transponder in order to complete the purchase associated with the train ride.

The ICC typically utilizes a contactless frontend (CLF) in order to communicate with a transponder. In this regard, the CLF typically contains a transceiver or the like that may receive information from the ICC and communicate information to a transponder or the like via a short range communication. The ICC typically communicates with the CLF via a Single Wire Protocol (SWP) interface (also referred to herein as a SWP communication channel) which is a point-to-point communication interface between the ICC and the CLF in a terminal.

Currently, when an ICC receives an update to a NFC application or a new NFC application over the air, in the manner described above, the SWP interface is typically not active. When the SWP interface is inactive or deactivated, the ICC is unable to initiate communication via the SWP interface between the ICC and the CLF. As such, the SWP interface typically must be reinitialized in order for the ICC to communicate relevant information, associated with the updated or new NFC application, to the CLF. When the SWP interface is reinitialized, the ICC typically must send the information associated with the updated or new NFC application to the CLF in order to register this information with the CLF so that the CLF may be reconfigured to operate based on this information. The information that the ICC communicates to the CLF upon re-initialization of the SWP interface may include parameters (e.g., radio frequency (RF) parameters such as for e.g., an RF technology type) associated with the updated or new NFC application and the CLF may need to be reconfigured based on these parameters in order to communicate with corresponding RF devices (e.g., transponders) that operate in accordance with the parameters of the updated or new NFC application.

Current mechanisms of reinitializing the SWP interface are typically inefficient and oftentimes result in an undesirable delay associated with the transfer of information from the ICC to the CLF. One mechanism of reinitializing the SWP interface is to turn the terminal off and then turn it back on again. Although this procedure typically reinitializes the SWP interface, it suffers from drawbacks associated with a delay corresponding to the time that it takes the user to turn the terminal off and turn the terminal back on again and it requires user action to manually turn the terminal off and on again, which can be quite cumbersome and annoying to a user of the terminal. Another mechanism of reinitializing the SWP interface consists of the terminal electrically resetting the ICC. This could be initiated by the ICC (e.g., utilizing a Refresh UICC reset feature) or by the user upon selection of a menu or the like on the terminal. Electrically resetting the ICC reinitializes the SWP interface which typically requires the user to re-enter the PIN code associated with the ICC. Using the electrical reset of the ICC to reinitialize the SWP interface suffers from drawbacks associated with an undesirable delay and this mechanism of reinitializing the SWP interface requires user action.

The undesirable delay in reinitializing the SWP interface by electrically resetting the ICC is associated with the time that it takes for the ICC to re-read many of the files that are stored in the ICC such as for example the user's contact information (e.g., phone book) and the time it takes for the terminal to perform a new service search and access the network service again. The ICC typically must re-read these files because it was electrically reset. This approach also requires the user to manually enter the PIN code which may be cumbersome and frustrating to the user. One other drawback of electrically resetting the ICC to reinitialize the SWP interface is that if the terminal is in the process of handling a call or is browsing the Internet or performing some other operation, the terminal will typically reject the refresh command and thus does not reinitialize the SWP because the terminal is busy. In this regard, re-initialization of the SWP interface typically fails.

The delays associated with reinitializing the SWP interface by turning the terminal off and on again or by electrically resetting the ICC may result in a failure in communication between the CLF and an RF device (e.g., transponder) when the CLF is within an appropriate range (e.g., 3 inches) of the RF device. For instance, in the example above relating to the public transportation payment application in which the user seeks to utilize the ICC of the terminal to pay the fare for a train ride, the payment transaction may fail if the user is trying to complete the transaction during the time (e.g., a delay time) that the SWP interface is not reinitialized. The transaction typically fails because the CLF has not yet been updated with the information (e.g., parameters) associated with the public transportation payment application and is typically unable to communicate with the transponder of the public transportation system until it receives this information from the ICC. In this regard, the parameters of the ICC associated with the public transportation payment application are not yet synchronized with the CLF.

It should be pointed out that one approach to overcoming the drawbacks of the delay associated with reinitializing the SWP interface by turning the terminal off and on again or electrically resetting the ICC is to keep the SWP interface activated or suspended at all times. However, this approach may severely impact the battery life of the terminal and may undesirably consume bandwidth and other resources of the terminal. As such, this approach may not be desirable for efficient use of the terminal's resources.

In view of the above drawbacks associated with reinitializing the SWP interface and keeping the SWP interface active at all times, it may be desirable to provide a new mechanism by which to reinitialize and activate the SWP interface so that the CLF may be updated with information received from the ICC in a quicker and more efficient manner.

### BRIEF SUMMARY

A method, apparatus and computer program product are therefore provided for reinitializing and activating a SWP communication channel as well as refreshing or updating a configuration of a contactless frontend device. The exemplary embodiments are configured to receive one or more updated or new applications (e.g., an NFC application) over the air (or via any other suitable mechanism) from a network entity (e.g., server) or the like. In response to receiving the updated or new applications the exemplary embodiments may provide the new or updated applications to an integrated circuit card (e.g., a smart card, such as for example, a user identity module (UIM)).

The ICC may determine that the new or updated application relates to a near field communication application which, when executed, may facilitate the exchange of data between the ICC and electronic devices (e.g., an RF device) when the ICC is within a proximity of the electronic devices. In response to the ICC determining that the updated or new application is a NFC application, the ICC may determine whether a SWP communication channel is active. The SWP communication channel is a point-to-point connection between the ICC and a contactless frontend device. The SWP communication channel must typically be active for the ICC to communicate with electronic devices via the CLF device when the ICC enters a proximity, range or distance of the electronic devices. It should be pointed out that the SWP communication channel is typically inactive in order to conserve resources of a terminal (e.g., mobile terminal) such as for example, bandwidth, battery life, processor speed, etc.

In response to the ICC determining that the SWP communication channel is inactive, the ICC may send an instruction to a processor of a terminal which may instruct the CLF device to activate the SWP communication channel, since the CLF device is typically the master of the SWP communication channel. In this regard, a processor of the CLF device may send a signal, command, instruction or the like to the SWP communication channel to activate the SWP communication channel. In response to activating the SWP communication channel, the ICC may send parameters (e.g., RF parameters) to the CLF device so that the CLF device may use and/or execute the updated or newly received application (e.g., NFC application) and so that the CLF device may communicate with electronic devices that operate according to these parameters.

In this regard, the exemplary embodiments may provide a mechanism to activate the SWP communication channel when desired, which conserves resources of a terminal. Additionally, since the exemplary embodiments may activate the SWP communication channel on the basis of a signal, command, instruction or the like generated by a processor, user interaction associated with reinitializing the SWP communication channel on the basis of turning a terminal off and on again or electrically resetting an ICC requiring re-entering a PIN code associated with the ICC are typically not required. As such, usage of the exemplary embodiments may result in a more user friendly terminal experience. Additionally, since the exemplary embodiments may activate the SWP communication channel on the basis of a signal, command, instruction or the like, generated by a processor, the delays associated with reinitializing the SWP communication channel on the basis of turning the terminal off and on again and electrically resetting the ICC requiring re-entering a PIN code are typically not present when using the exemplary embodiments of the invention.

In one exemplary embodiment, a method for reinitializing and activating a SWP communication channel as well as refreshing or updating a configuration of a contactless frontend device is provided. The method may include determining whether one or more parameters associated with an at least one application are to be sent to a first device in order for the first device to execute the application and determining whether a Single Wire Protocol (SWP) communication channel is active. The method may further include generating a command to activate the SWP communication channel in response to receiving a first indication that the SWP communication channel is inactive or suspended.

In another exemplary embodiment, a computer program product for reinitializing and reactivating a SWP communication channel as well as refreshing or updating a configuration of a contactless frontend device is provided. The computer program product includes at least one computer-readable storage medium having computer-executable program code instructions stored therein. The computer-executable program code instructions may include program code instructions for determining whether one or more parameters associated with at least one application are to be sent to a first device in order for the first device to execute the application and for determining whether a Single Wire Protocol (SWP) communication channel is active. The computer program product may also include program code instructions for generating a command to activate the SWP communication channel in response to receiving a first indication that the SWP communication channel is inactive or suspended.

In another exemplary embodiment, an apparatus for reinitializing and activating a SWP communication channel as well as refreshing or updating a configuration of a contactless frontend device is provided. The apparatus may include a processor and a memory including computer program code. The memory and the computer program code are configured to, with the processor, cause the apparatus to at least perform operations including determining whether one or more parameters associated with at least one application are to be sent to a first device in order for the first device to execute the application and determining whether a Single Wire Protocol (SWP) communication channel is active. The computer program code may further cause the apparatus to generate a command to activate the SWP communication channel in response to receiving a first indication that the SWP communication channel is inactive or suspended.

Embodiments of the invention may provide a method, apparatus and computer program product for improving performance between smart cards such as, for example, integrated circuit cards and electronic devices (e.g., RF devices). As a result, for example, mobile terminal users may enjoy improved capabilities with respect to exchanging information with these electronic devices.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a schematic block diagram of a system according to an exemplary embodiment of the invention;

FIG. 2 is a schematic block diagram of an apparatus for reinitializing a SWP communication channel and refreshing or updating a configuration of a CLF device according to an exemplary embodiment of the invention;

FIG. 3 is a signal flow diagram related to a method of reinitializing a SWP communication channel and refreshing or updating a configuration of a CLF device according to an exemplary embodiment of the invention;

FIG. 4 is a schematic block diagram of a system for reinitializing a SWP communication channel and refreshing or updating a configuration of a CLF device according to an exemplary embodiment of the invention; and

FIG. 5 is a schematic block diagram of an apparatus according to an exemplary embodiment of the invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the present invention. Moreover, the term “exemplary”, as used herein, is not provided to convey any qualitative assessment, but instead merely to convey an illustration of an example. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

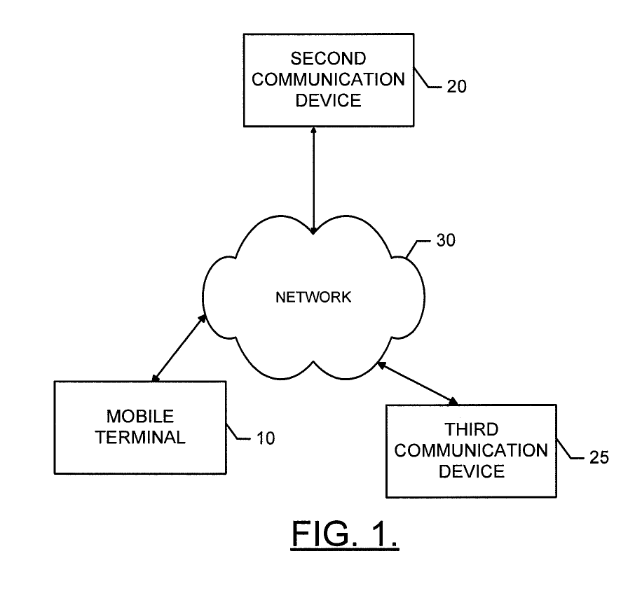

FIG. 1 illustrates a generic system diagram in which a device such as a mobile terminal 10 is shown in an exemplary communication environment. As shown in FIG. 1, an embodiment of a system in accordance with an example embodiment of the present invention may include a first communication device (e.g., mobile terminal 10) and a second communication device 20 capable of communication with each other via a network 30. In some cases, embodiments of the present invention may further include one or more additional communication devices, one of which is depicted in FIG. I as a third communication device 25. In some embodiments, not all systems that employ embodiments of the present invention may comprise all the devices illustrated and/or described herein. While several embodiments of the mobile terminal 10 and/or second and third communication devices 20 and 25 may be illustrated and hereinafter described for purposes of example, other types of terminals, such as portable digital assistants (PDAs), pagers, mobile televisions, mobile telephones, gaming devices, laptop computers, cameras, video recorders, audio/video players, radios, global positioning system (GPS) devices, Bluetooth headsets, Universal Serial Bus (USB) devices or any combination of the aforementioned, and other types of voice and text communications systems, can readily employ embodiments of the present invention. Furthermore, devices that are not mobile, such as servers and personal computers may also readily employ embodiments of the present invention.

The network 30 may include a collection of various different nodes (of which the second and third communication devices 20 and 25 may be examples), devices or functions that may be in communication with each other via corresponding wired and/or wireless interfaces. As such, the illustration of FIG. 1 should be understood to be an example of a broad view of certain elements of the system and not an all inclusive or detailed view of the system or the network 30. Although not necessary, in some embodiments, the network 30 may be capable of supporting communication in accordance with any one or more of a number of First-Generation (1G), Second-Generation (2G), 2.5G, Third-Generation (3G), 3.5G, 3.9G, Fourth-Generation (4G) mobile communication protocols, Long Term Evolution (LTE), and/or the like. In some embodiments, the network 30 may be a point-to-point (P2P) network.

One or more communication terminals such as the mobile terminal 10 and the second and third communication devices 20 and 25 may be in communication with each other via the network 30 and each may include an antenna or antennas for transmitting signals to and for receiving signals from a base site, which could be, for example a base station that is a part of one or more cellular or mobile networks or an access point that may be coupled to a data network, such as a Local Area Network (LAN), a Metropolitan Area Network (MAN), and/or a Wide Area Network (WAN), such as the Internet. In turn, other devices such as processing elements (e.g., personal computers, server computers or the like) may be coupled to the mobile terminal 10 and the second and third communication devices 20 and 25 via the network 30. By directly or indirectly connecting the mobile terminal 10 and the second and third communication devices 20 and 25 (and/or other devices) to the network 30, the mobile terminal 10 and the second and third communication devices 20 and 25 may be enabled to communicate with the other devices or each other, for example, according to numerous communication protocols including Hypertext Transfer Protocol (HTTP) and/or the like, to thereby carry out various communication or other functions of the mobile terminal 10 and the second and third communication devices 20 and 25, respectively.

Furthermore, although not shown in FIG. 1, the mobile terminal 10 and the second and third communication devices 20 and 25 may communicate in accordance with, for example, radio frequency (RF), near field communication (NFC), Bluetooth (BT), Infrared (IR) or any of a number of different wireline or wireless communication techniques, including Local Area Network (LAN), Wireless LAN (WLAN), Worldwide Interoperability for Microwave Access (WiMAX), WiFi, Ultra-Wide Band (UWB), Wibree techniques and/or the like. As such, the mobile terminal 10 and the second and third communication devices 20 and 25 may be enabled to communicate with the network 30 and each other by any of numerous different access mechanisms. For example, mobile access mechanisms such as Wideband Code Division Multiple Access (W-CDMA), CDMA2000, Global System for Mobile communications (GSM), General Packet Radio Service (GPRS) and/or the like may be supported as well as wireless access mechanisms such as WLAN, WiMAX, and/or the like and fixed access mechanisms such as Digital Subscriber Line (DSL), cable modems, Ethernet and/or the like. Additionally, it should be pointed out that the mobile terminal 10 and the second and third communication devices 20 and 25 may communicate with each other via one or more communication channels. In this regard, the mobile terminal and the second and third communication devices 20 and 25 may utilize the communication channels to exchange one or more applications (e.g., executable software) between each other as well as any other suitable data, information, content or the like. Some of the applications may be NFC applications which may include but are not limited to Mifare™, Mifare4Mobile™, Felica™ applications or the like. The NFC applications may exchange data (e.g., RF data) with short range communication devices (e.g., RF devices such as for e.g., transponders, tags or the like) when a communication device (e.g., mobile terminal 10) executing the NFC application is within a given proximity, range or distance of a corresponding short range communication device. Additionally, some of the NFC applications may, but need not, be payment applications configured to facilitate payment of a transaction. In this regard, when the communication device enters an appropriate range (e.g., 4 inches) of the short range communication device, the communication device may execute the NFC application and may provide information associated with the identity of the user of the communication device as well as account information (e.g., credit card account number, debit card account number, etc.) to the short range communication device for payment of a transaction (e.g., purchase of a ticket from a public transportation system, purchase of merchandise, etc.).

In example embodiments, the first communication device (e.g., the mobile terminal 10) may be a mobile communication device such as, for example, a wireless telephone or other devices such as a personal digital assistant (PDA), mobile computing device, camera, video recorder, audio/video player, positioning device, game device, television device, radio device, or various other like devices or combinations thereof. The second communication device 20 may be a mobile or fixed communication device. However, in one example, the second communication device 20 may be a server, remote computer or terminal such as a personal computer (PC) or laptop computer. In some embodiments the third communication device 25 may include an RF device such as a transponder, tag or the like that is configured to exchange RF data with the mobile terminal 10 and/or the second communication device 20 when the mobile terminal and/or the second communication device are within a proximity, range or distance of the third communication device 25.

In an exemplary embodiment, the network 30 may be an ad hoc or distributed network arranged to be a smart space. Thus, devices may enter and/or leave the network 30 and the devices of the network 30 may be capable of adjusting operations based on the entrance and/or exit of other devices to account for the addition or subtraction of respective devices or nodes and their corresponding capabilities. In an exemplary embodiment, one or more of the devices in communication with the network 30 may employ a user identity module (UIM) and a contactless frontend (CLF) (also referred to herein as a contactless frontend device). The UIM and the contactless frontend device may communicate with each other via an interface or communication channel (also referred to herein as a SWP communication channel) according to a Single Wire Protocol, which is a point-to-point connection between the UIM and the contactless frontend device. As described more fully below, the UIM may send data to the CLF via the SWP communication channel. In this regard, the UIM may send data associated with one or more applications (e.g., NFC applications) and parameters (e.g., RF parameters) as well as any other suitable data to the CLF device and the CLF device may utilize this information to communicate with one or more electronic devices (e.g., RF devices).

In an exemplary embodiment, the mobile terminal 10 and the second and third communication devices 20 and 25 may be configured to include the UIM and the CLF device. However, in other alternative embodiments the mobile terminal 10 may include the UIM and the CLF device and the second communication device 20 may be a network entity such as a server or the like that is configured to communicate with the mobile terminal 10. In this alternative exemplary embodiment, the third communication device 25 may include an RF device (e.g., transponder, tag or the like) that is configured to communicate with the CLF device as well as other short range transceivers of the mobile terminal 10. The short range transceivers of the mobile terminal 10 may include, but are not limited to, a short range radio frequency transceiver and/or interrogator, an infrared transceiver, and a Bluetooth™ (BT) transceiver.

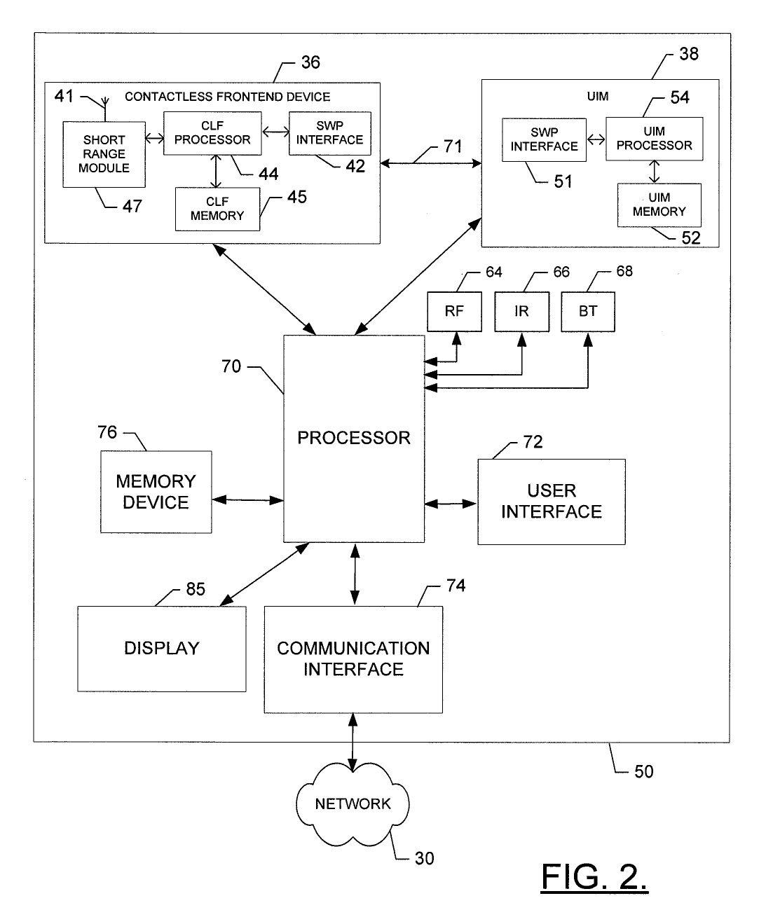

In an exemplary embodiment, the mobile terminal as well as the second and third communication devices 20 and 25 may employ an apparatus (e.g., apparatus of FIG. 2) capable of employing embodiments of the invention.

FIG. 2 illustrates a schematic block diagram of an apparatus that may benefit from embodiments of the invention. An exemplary embodiment of the invention will now be described with reference to FIG. 2, in which certain elements of an apparatus 50 for reinitializing and activating a SWP communication channel and refreshing or updating a configuration of a CLF device are displayed. The apparatus 50 of FIG. 2 may be employed, for example, on the mobile terminal 10 (and/or the second communication device 20 or the third communication device 25). However, the apparatus 50 may alternatively be embodied at a variety of other devices, which may be mobile devices. In some cases, embodiments may be employed on a combination of devices. Accordingly, some embodiments of the present invention may be embodied wholly at a single device (e.g., the mobile terminal 10), by a plurality of devices in a distributed fashion (e.g., on one or a plurality of devices in a P2P network) or by devices in a client/server relationship. Furthermore, it should be noted that the devices or elements described below may not be mandatory and thus some of the devices or elements may be omitted in certain embodiments.

The apparatus 50 of FIG. 2 may include or otherwise be in communication with a processor 70, a user interface 72, a communication interface 74 and a memory device 76. The memory device 76 may include, for example, volatile and/or non-volatile memory. The memory device 76 may be configured to store information, data, files, directories, applications, instructions or the like for enabling the apparatus to carry out various functions in accordance with exemplary embodiments of the present invention. For example, the memory device 76 could be configured to buffer input data for processing by the processor 70. Additionally or alternatively, the memory device 76 could be configured to store instructions for execution by the processor 70. As yet another alternative, the memory device 76 may be one of a plurality of databases that store information and/or media content.

The processor 70 may be embodied in a number of different ways. For example, the processor 70 may be embodied as various processing means such as a processing element, a coprocessor, a controller or various other processing devices or circuitry including integrated circuits such as, for example, an ASIC (application specific integrated circuit), an FPGA (field programmable gate array), a hardware accelerator, or the like. In an exemplary embodiment, the processor 70 may be configured to execute instructions stored in the memory device 76 or otherwise accessible to the processor 70. As such, whether configured by hardware or software methods, or by a combination thereof, the processor 70 may represent an entity (e.g., physically embodied in circuitry) capable of performing operations and functions according to embodiments of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70, which may otherwise be a general purpose processing element or other functionally configurable circuitry if not for the specific configuration provided by the instructions, to perform the algorithms and operations described herein. However, in some cases, the processor 70 may be a processor of a specific device (e.g., a mobile terminal) adapted for employing embodiments of the present invention by further configuration of the processor 70 by instructions for performing the algorithms and operations described herein. The processor 70 may be configured to operate a connectivity program, such as a conventional Web browser. The connectivity program may then enable the apparatus 50 to transmit and receive Web content, such as location-based content, according to a Wireless Application Protocol (WAP), for example.

Meanwhile, the communication interface 74 may be any means such as a device or circuitry embodied in either hardware, software, or a combination of hardware and software that is configured to receive and/or transmit data from/to a network and/or any other device or module in communication with the apparatus 50. In this regard, the communication interface 74 may include, for example, an antenna (or multiple antennas) and supporting hardware and/or software for enabling communications with a wireless communication network (e.g., network 30). The communication interface 74 may receive and/or transmit data via one or more communication channels. Additionally in some embodiments the communication interface 74 may include hardware and/or software for supporting communication via Universal Serial Bus (USB), Ethernet or other mechanisms.

The user interface 72 may be in communication with the processor 70 to receive an indication of a user input at the user interface 72 and/or to provide an audible, visual, mechanical or other output to the user. As such, the user interface 72 may include, for example, a keyboard, a mouse, a joystick, a display 85, a touch screen, a microphone, a speaker, or other input/output mechanisms.

It should be pointed out that the processor 70 may comprise user interface circuitry configured to control at least some functions of one or more elements of the user interface. The processor and/or user interface circuitry of the processor may be configured to control one or more functions of one or more elements of the user interface through computer program instructions (e.g., software and/or firmware) stored on a memory accessible to the processor (e.g., volatile memory, non-volatile memory, and/or the like).

As shown in FIG. 2, the apparatus 50 may also include one or more means for sharing and/or obtaining data. For example, the apparatus may comprise a short range radio frequency (RF) transceiver and/or interrogator 64 so data may be shared with and/or obtained from electronic devices in accordance with RF techniques. The mobile terminal may comprise other short range transceivers, such as, for example an infrared (IR) transceiver 66, a Bluetooth™ (BT) transceiver 68 operating using Bluetooth™ brand wireless technology developed by the Bluetooth™ Special Interest Group, and/or the like. The Bluetooth transceiver 68 may be configured to operate according to Wibree™ radio standards. In this regard, the mobile terminal 10 and, in particular, the short range transceiver may be capable of transmitting data to and/or receiving data from electronic devices within a proximity of the apparatus, such as within 10 meters, for example. Although not shown, the apparatus may be configured to transmit and/or receive data from electronic devices according various wireless networking techniques, including Wireless Fidelity (Wi-Fi), WLAN techniques such as IEEE 802.11 techniques, and/or the like.

The apparatus 50 may further include a user identity module (UIM) 38. The UIM 38 may include a memory device (e.g., UIM memory 52), a processor (e.g., UIM processor 54) and an interface (e.g., interface 51 also referred to herein as a SWP interface 51) configured to communicate via communication channel 71 according to a Single Wire Protocol (also referred to herein as a SWP communication channel 71). The UIM 38 may be an example of a smart card and may include, for example, a Subscriber Identity Module (SIM), an Integrated Circuit Card (ICC), a Universal Integrated Circuit Card (UICC), a universal subscriber identity module (USIM), a removable user identity module (R-UIM), etc. When the UIM 38 is an R-UIM, the UIM 38 may be removable from the apparatus 50. In one example embodiment in the context of GSM and UMTS applications, for example, when the UIM 38 is a UICC, the UICC may include a subscriber identity module (SIM) application, universal SIM (USIM) application, internet protocol multimedia services identity module (ISIM) application or the like for accessing corresponding public land mobile networks (PLMNs), although it should be understood that one or more of these applications may also be used to access one or more other networks. The memory 52 of the UIM 38 may store information elements related to a mobile subscriber and any other suitable data. For instance, the memory of the UIM 38 may store information elements (e.g., a PIN code) related to and/or for validating a mobile subscriber to a network operator and/or to the apparatus 50. In this regard, content of the UIM 38 may not be accessible until the mobile subscriber is validated. The UIM 38 may store payment card information associated with the mobile subscriber. As referred to herein payment card information relates to one or more accounts that are backed and supported by one or financial institutions (e.g., bank, credit card companies) holding funds belonging to the cardholder, or offering credit to the cardholder (e.g., credit and/or debit card information associated with the mobile subscriber).

Additionally, the UIM 38 may store applications and identifiers (IDs) that identify the applications and in some cases the processor 54 of the UIM 38 may execute the applications and issue or respond to commands. In this regard, the UIM 38 may send commands to a CLF device 36 and may respond to commands from the processor 70 and/or the CLF device 36. The UIM 38 may communicate with the CLF device 36 via the communication channel 71 according to a Single Wire Protocol. (See, e.g., European Telecommunications Standards Institute (ETSI) 102 613 V7.5.0, April 2009, for more information associated with the SWP) In this regard, the UIM 38 may communicate with the CLF device 36 via communication channel 71 by accessing its SWP interface 51.

The UIM processor 54 may be a coprocessor, controller, microprocessor or other processing element including integrated circuits (e.g., embodied as an ASIC or FPGA) or circuitry configured to execute instructions, which may be stored in UIM memory 52, or perform other logical functions or corresponding operations described herein.

It should also be pointed out that the UIM 38 may operate in a card emulation mode as well as a reader mode. In the card emulation mode, the processor 54 of the UIM 38 may cause the UIM to emulate a contactless card through the CLF device 36. In this regard, when the CLF device detects a signal (e.g., an interrogation signal) from an electronic device such as an RF device, the processor of the UIM 38 may send information (e.g., identification information of the mobile subscriber, payment information, etc.) to the electronic device via the CLF device. In the reader mode, the processor 54 may cause the UIM 38 to act as a contactless reader through the CLF device. In this regard, the CLF device may actively transmit signals in order to detect an electronic device and to receive signals from the electronic device. The signals received from the electronic device may contain data (e.g., RF data, NFC data or the like) and the CLF device may send this received data to the processor 54 of the UIM 38. Based on the content of this data (e.g., request for mobile subscriber identification (ID) data), the processor 54 of the UIM 38 may send information (e.g., mobile subscriber ID data) to the electronic device via the CLF device 36.

Some of the applications stored in the memory of the UIM 38 may be NFC applications which when executed by the processor 54 or processor 70 may facilitate the exchange of data with electronic devices, such as for example RF devices, when the apparatus 50 is within a proximity, range or distance of the electronic devices. One or more of the NFC applications may facilitate the payment of a transaction associated with the mobile subscriber, as described more fully below.

It should be pointed out that the UIM 38 may receive one or more updates to applications currently stored in its memory 52 and may receive one or more new applications, such as for example new NFC applications, from a network entity (e.g., server) over the air, for example via cellular communication signals. Additionally, the apparatus 50 may receive the updated or new applications by downloading this information from the network entity (e.g., server) via network 30 (e.g., Internet) and the processor 70 of the apparatus may provide the updated or new application to a memory of the UIM 38. The download may occur when the processor 70 executes the connectivity program associated with the Web browser.

The CLF device 36 may include a memory (e.g., CLF memory 45), an interface (e.g., interface 42 also referred to herein as a SWP interface 42) configured to communicate via communication channel 71 according to a Single Wire Protocol, a processor (e.g., CLF processor 44) and a short range module (e.g., short range module 47). The memory of the CLF device 36 is configured to store information received from the processor of the UIM 38 as well as information received from one or more electronic devices (e.g., RF devices) that may be external to the apparatus 50 and information received from the processor 70. The processor of the CLF device 36 may communicate with the UIM 38 via the SWP communication channel 71 by accessing the SWP interface 42. In one embodiment, the CLF device 36 may be embodied within the UIM 38.

The SWP communication channel 71 is typically deactivated in order to conserve resources of the apparatus 50 such as for example bandwidth, battery life, processing speed, etc. When the SWP communication channel 71 is deactivated, the processor 44 of the CLF device 36 may activate the SWP communication channel 71 in response to receiving a command from the processor 70. The processor of the CLF device 36 may activate the channel 71 by sending a signal, instruction, command or the like to the SWP communication channel 71 via SWP interface 42. The processor 70 may send the CLF device 36 the command to activate the SWP communication channel 71 when the UIM 38 has information (e.g., parameters, like RF parameters, associated with a new NFC application) that needs to be sent to the CLF device 36, as described more fully below. In this regard, the CLF device 36 may be the master of the SWP communication channel 71.

The processor 44 of the CLF device 36 may be a coprocessor, controller, microprocessor or other processing element including integrated circuits (e.g., embodied as an ASIC or FPGA) or circuitry configured to execute instructions, which may be stored in CLF memory 45, or perform other logical functions or corresponding operations described herein.

The short range module 47 may be a transceiver having an antenna 41 configured to transmit and receive short range communication data (e.g., signals). In this regard, the short range module may transmit and/or receive short range communication data in accordance with a number of different short range communication techniques, including but not limited to RF, IR, and BT techniques. The short range module 47 may operate in accordance with one or more frequencies (e.g., 13.56 MHz) or one or more frequency bands. The short range module 47 may be configured to communicate with other electronic devices such as for example RF devices which may be external to the apparatus 50. The short range module 47 is configured to communicate with these other electronic devices when the apparatus 50 is within a predetermined proximity, range or distance of an electronic device. In this regard, the short range module 47 may send a response signal to an electronic device upon receiving an interrogation signal from the electronic device when the apparatus 50 is within a predetermined proximity of the electronic device. In this manner, the short range module 47 may operate in a passive mode. The short range module 47 may operate in the passive mode when the UIM 38 is configured by its processor 54 to operate in the card emulation mode. Alternatively, the short range module 47 may actively send signals to and receive signals from the electronic device when the apparatus 50 is within a predetermined proximity of the electronic device. In this manner, the short range module 47 may operate in an active mode. The short range module 47 may operate in the active mode when the UIM 38 is configured by its processor 54 to operate in the reader mode.

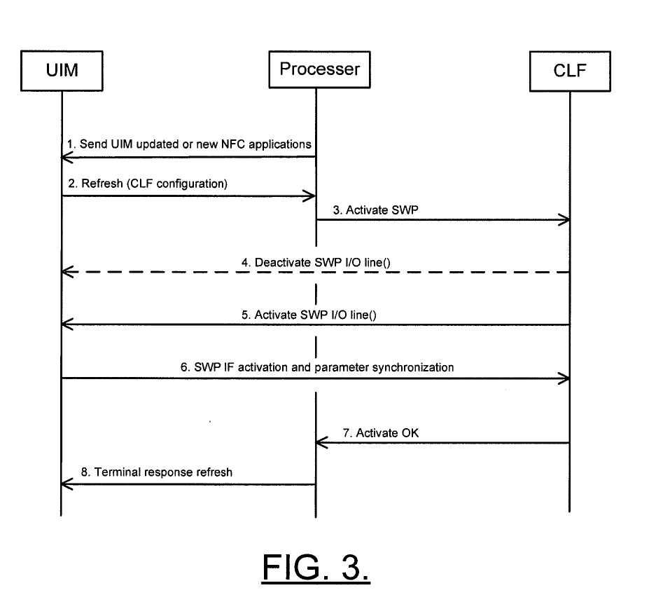

Referring now to FIG. 3, a signal flow for reinitializing a SWP communication channel and refreshing or updating a configuration of a CLF device according to an exemplary embodiment is provided. As described above, the processor 70 may receive an update to an application(s) (e.g., NFC application) that is currently stored in a memory (e.g., UIM memory 52) and may receive a new application(s) such as for example a new NFC application. According to this embodiment, in step 1, the processor 70 may provide the updated or new NFC application to the UIM 38. The processor 54 of the UIM may store the updated or new application and corresponding application IDs in memory 52. In response to receiving an updated NFC application or a new NFC application, the processor of the UIM 38 may desire to communicate data, via the SWP communication channel 71, to the CLF device 36. The data that the processor of the UIM 38 may desire to communicate to the CLF device 36 may be related to parameters such as for example RF parameters associated with the updated NFC application or the new NFC application. In this regard, the CLF device may need to be registered with the RF parameters and reconfigured on the basis of the RF parameters in order to use and/or execute the updated or new NFC application and in order to communicate with electronic devices (e.g., RF devices) that may be external to the apparatus 50. The electronic devices may also utilize these parameters, associated with the NFC application, and the CLF device 36 typically needs these parameters to be able to communicate with the electronic devices.

The parameters which the CLF device 36 may need to be registered and reconfigured with in order to use and/or execute the updated NFC application or the new NFC application and to communicate with one or more electronic devices may include, but are not limited to, data associated with an RF technology type, read/write access rights, a tunneling mode capability, a type of coding, physical link layer parameters such as for example a maximum data rate, and a maximum frame size as well as any other suitable data.

When the processor of the UIM 38 desires to communicate the parameters associated with the updated or new NFC application to the CLF device 36, the processor of the UIM 38 may determine whether the SWP communication channel 71 is activated, suspended or deactivated. When there is no activity on the SWP communication channel other than idle bits from the CLF device to the UIM for a given specific bit sequence, the SWP communication channel may be in a suspended state. In the suspended state both the CLF device 36 and the UIM 38 may typically resume communication on the SWP communication channel in response to the processor of the CLF device setting a voltage signal (S1) to high on the SWP communication channel, which causes the UIM to receive a current signal (S2). However, the exemplary embodiments also enable the CLF device and the UIM to resume communication when the SWP communication channel is in the suspended state by deactivating the SWP communication channel and then activating the SWP communication channel again in the manner described more fully below. It should be pointed out that when the SWP communication channel 71 is deactivated, the UIM 38 may be unable to communicate with the CLF device 36. In step 2, in response to the processor of the UIM 38 determining that the SWP communication channel 71 is deactivated or suspended, the processor of the UIM 38 may send a refresh command (also referred to herein as a Refresh (CLF configuration) or Refresh (CLF conf) command) to the processor 70 requesting the processor 70 to instruct the CLF device 36 to activate the SWP communication channel 71. The data in the refresh command may also include one or more IDs associated with one or more applications stored on the UIM 38 including the updated or new NFC application.

In step 3, in response to receiving the refresh command from the UIM 38, the processor 70 may generate a command (also referred to herein as an Activate SWP message) and may send the command to the CLF device 36 to activate the SWP communication channel 71 since the CLF device 36 is typically the master of the SWP communication channel 71. Optionally, in step 4, in response to receiving the command from the processor 70 to activate the SWP communication channel 71, the processor 44 of the CLF device 36 may deactivate the SWP communication channel 71, in instances in which the processor of the CLF device 36 determines that the SWP communication channel is suspended, and the processor of the CLF device 36 may generate a message (also referred to herein as Deactivate SWP Input/Output (I/O) line( ) message) that may be sent to the UIM 38 indicating that the SWP communication channel 71 is deactivated. In instances in which the SWP communication channel 71 is suspended, the deactivation of the SWP communication channel may be desired in order to reactivate the communication channel. In an exemplary embodiment, the processor of the CLF device 36 may deactivate the SWP communication channel 71 by sending a signal, instruction, command or the like to the SWP communication channel 71 via SWP interface 42. For instance, if the SWP communication channel is in a suspended state, the processor of the CLF device may deactivate the SWP communication channel by keeping a voltage associated with a signal (e.g., signal S1) that is applied to the SWP communication channel low for a specific period of time. It should be pointed out that when the processor of the CLF device determines that the SWP communication channel is inactive or deactivated as opposed to being suspended, the signal flow may proceed to step 5 without requiring the processor of the CLF device 36 to deactivate the SWP communication channel 71.

In step 5, the processor 44 of the CLF device 36 may activate the SWP communication channel and may generate a message (also referred to herein as an Activate SWP I/O line( ) message) that may be sent to the UIM 38 indicating that the SWP communication channel 71 is activated and reinitialized and ready for communication to be exchanged between the UIM 38 and the CLF device 36. In an exemplary embodiment, the processor of the CLF device 36 may activate the SWP communication channel 71 by sending a signal, instruction, command or the like to the SWP communication channel 71 via SWP interface 42.

In step 6, in response the SWP communication channel 71 being successfully activated by the processor of the CLF device 36 and in response to receiving the Activate SWP I/O line( ) message, the processor of the UIM 38 may send the parameters, in a message or signal (also referred to herein as a SWP interface (IF) activation and parameter synchronization message), associated with the updated or new NFC application to the CLF device 36. In this manner, the CLF device 36 may be synchronized with the parameters associated with the updated or new NFC application that may be stored in a memory of the UIM 38. Upon receiving these parameters, the processor 44 of the CLF device 36 may register the parameters in its memory and reconfigure the CLF device 36 on the basis of these parameters so that the CLF device 36 is configured to operate in accordance with these parameters to use and/or execute the updated or new NFC application and to communicate with corresponding electrical devices (e.g., RF devices) which may also be operating according to these parameters.

After the processor 44 of the CLF device 36 configures the CLF device with the parameters associated with the new or updated NFC application, the CLF device 36 may communicate with one or more electrical devices (e.g., RF devices) which also operate according to these parameters. In step 7, in response to the processor of the CLF device 36 receiving the parameters associated with the new or updated NFC application, the processor 44 of the CLF device may generate and send an acknowledgment message or signal (also referred to herein as an Activate OK message or signal) to the processor 70 indicating that the parameters were received from the UIM 38. It should be pointed out that if the processor 44 of the CLF device 36 does not receive the parameters from the UIM 38 in a predetermined time period, the processor 44 of the CLF device may determine that an error occurred and that the SWP communication channel 71 was not successfully activated. In this regard, the Activate OK message that may be sent by the processor 44 of the CLF device to the processor 70 may contain data indicating that an error occurred and that the activation of the SWP communication channel 71 failed. In step 8, in response to receiving the Activate OK message, the processor 70 may examine the data associated with the Activate OK message and may send a message (also referred to herein as a Terminal response refresh message) to the UIM 38 indicating whether the SWP communication channel 71 was activated successfully or whether the activation of the SWP communication channel 71 failed.

In instances in which the processor of the UIM 38 may determine that the SWP communication channel 71 is activated prior to step 2, the processor 54 of the UIM 38 may send the parameters associated with the new or updated NFC application to the CLF device 36 and the processor of the CLF device may register the parameters in its memory and reconfigure the CLF device and may communicate with one or more electronic devices in a manner analogous to that discussed above. However, it should be pointed out that in many instances, the SWP communication channel 71 may be deactivated to conserve resources in the apparatus 50, as described above.

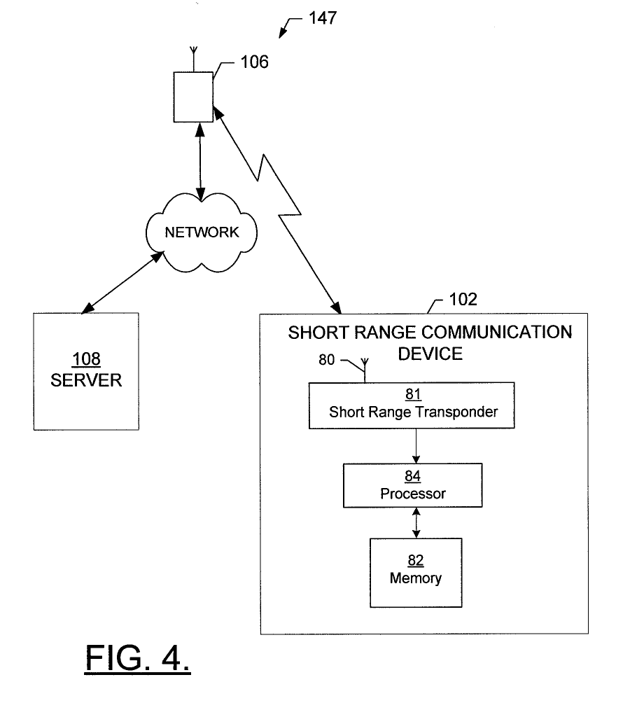

Referring now to FIG. 4, an exemplary embodiment of a system for reinitializing and activating a SWP communication channel and refreshing or updating a configuration of a CLF device according to an exemplary embodiment is provided. The system 147 may include an intermediary device 106, such as for example apparatus 50 (e.g., mobile terminal 10), a server 108 (e.g., second communication device 20) and a short range communication device 102 (e.g., third communication device 25).

The short range communication device 102 may include a tag or transceiver such as a short range transponder 81 having an antenna 80. The short range communication device 102 may also include a processor 84 and a memory 82. The short range transponder 81 of device 102 may be configured to operate in accordance with one or more frequencies or one or more frequency bands. Additionally, the short range transponder 81 may communicate with other electronic devices such as for example, the intermediary device 106 as well as other electronic devices. In this regard, the short range transponder 81 may communicate with other electronic devices according to RF, BT, IR or any other suitable short range communication techniques. The short range transponder 81 may communicate with intermediary device 106 when intermediary device 106 is within a given proximity, range or distance of the short range communication device 102. In this regard, the short range transponder 81 may send one or more interrogation signals to the intermediary device 106 when the intermediary device 106 is within the proximity of the short range communication device 102. The interrogation signals may excite or trigger the intermediary device 106 to send data (e.g., RF data signals) to the short range communication device 102. In an exemplary embodiment, the short range transponder 81 may be a NFC tag.

The memory 82 may store one or more instructions associated with one or more applications (e.g., NFC applications), application IDs, parameters (e.g., RF parameters) associated with these applications as well as any other suitable data. At least one of the applications may be an NFC payment application, which when executed may facilitate payment of a transaction when the intermediary device 106 is within the proximity of the short range communication device 102. The processor 84 may be a controller or other processing element configured to execute instructions, which may be stored in memory 82 or perform other logical operations or functions of the short range communication device 102 as described herein. The processor 84 may be embodied as an ASIC or an FPGA.

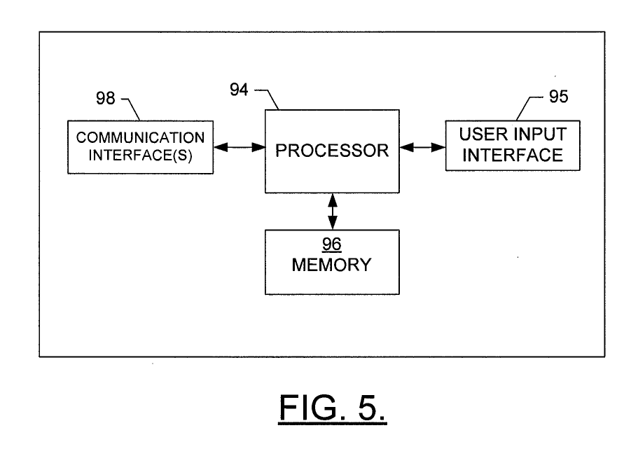

The server 108 may include a user input interface (e.g., user input interface 95), a processor (e.g., processor 94), a memory (e.g., memory 96) and one or more communication interfaces (e.g., communication interface(s) 98). (See e.g., FIG. 5)

An exemplary embodiment of the invention will now be described with reference to FIG. 4. For purposes of illustration and not of limitation, consider an example in which a user (e.g., mobile subscriber) of the intermediary device 106 (e.g., apparatus 50) desires to use the UIM 38 to pay for a weekly pass to use the Paris Metro, which is a subway system consisting of several subway trains. In this exemplary embodiment, the server 108 and the short range communication device 102 may be maintained by the Paris Metro rapid transit system. The user may access the Metro ticket sales office and utilize the RF transceiver 64, IR transceiver 66 or BT transceiver 68 of the apparatus 50 to read a NFC tag (e.g., short range transponder 81 in one embodiment) for using the Metro for one week. The processor 70 of the intermediary device 106 may provide the information received from the NFC tag to the UIM 38 and the processor 70 of the intermediary device 106 may send a message to the server 108, which may be a network device or entity, in response to providing the UIM with the information from the NFC tag. For instance, the information received from the NFC tag may specify that there is an NFC application (e.g., Mifare™, Mifare4mobile™, Felica™, etc.) required for purchasing the weekly pass to use the Metro and in this regard, the processor 70 may send a message to the server 108 requesting this NFC application.

It should be pointed out that the message that the processor 70 sends to the server via the network (e.g., network 30) may be a short message service (SMS) message requesting the NFC application. In response to receiving the SMS message from the processor 70, the processor of the server 108 may initiate a point-to-point data download of the NFC application to the apparatus 50 and upon receiving the NFC application the processor 70 may provide the NFC application to the memory of the UIM 38. It should be pointed out that processor 70 of the intermediary device 106 may communicate with the server 108 according other suitable mechanisms in order to receive the NFC application. For instance, the processor 70 may execute a connectivity program associated with a Web browser to access a web page associated with a Uniform Resource Identifier (URI) of the server 108 and in response to accessing a web page associated with the URI, the processor 70 may download the NFC application and provide the downloaded NFC application to the memory of the UIM 38. Alternatively, the processor 70 of the intermediary device may communicate with the server 108 via a network (e.g., network 30) to download the NFC application from the server 108 according to a Bearer Independent Protocol (BIP) which may use an Internet Protocol. In response to receiving the NFC application from the server 108 according to the BIP, the processor 70 may provide the NFC application to a memory of the UIM 38.

The NFC application may contain data corresponding to specific parameters (e.g., RF parameters) associated with the payment system of the Paris Metro. In order for the newly received NFC application to be used and/or executed, the parameters associated with the NFC application should be provided to the CLF device 36 by the processor of the UIM 38. In this regard, the processor of the UIM 38 may determine whether the SWP communication channel 71 is deactivated or suspended. In response to the processor 54 determining that the SWP communication channel 71 is deactivated or suspended, the processor 54 may send a refresh command to the processor of the intermediary device 106 requesting the processor 70 to instruct the CLF device 36 to activate the SWP communication channel 71. The refresh command may include data identifying one or more NFC applications stored in the memory of the UIM 38 which may include the new NFC application received from server 108. The data identifying the NFC applications may be associated with one or more identifiers (IDs) that identify the NFC applications.

In response, the processor of the CLF device 36 may deactivate and then activate the SWP communication channel 71 by sending a signal to the SWP communication channel 71 for example. When the processor of the CLF device 36 activates the SWP communication channel 71, the processor of the CLF device may generate a message that may be sent to the UIM 38 indicating that the SWP communication channel is active and reinitialized and may specify that data may be exchanged between the CLF device and the UIM.

In response to the processor of the UIM 38 receiving the message that the SWP communication channel is active and reinitialized, the processor of the UIM 38 may send one or more parameters associated with the NFC application, received from server 108, to the CLF device. In this regard, the processor of the CLF device may register the parameters in its memory and utilize the parameters to reconfigure the CLF device to operate on the basis of the parameters. In this manner, the CLF device 36 may be synchronized with the parameters associated with the newly received NFC application that may be stored in the memory of the UIM 38. Upon being reconfigured according the parameters, the processor of the CLF device may use and/or execute the corresponding NFC application and communicate with the NFC tag (e.g., short range transponder 81) to facilitate payment for usage of the Paris Metro for one week. For instance, the processor of the CLF device may detect an interrogation signal transmitted by the NFC tag requesting payment for the weekly fare to use the Paris Metro and in response, the processor of the UIM 38 may send payment information (e.g., credit card information of the user or mobile subscriber) to the NFC tag, via the CLF device, in order to complete the financial transaction. It should be pointed out that the UIM may be operating in a card emulation mode, in embodiments in which the CLF device detects an interrogation signal sent or transmitted by the NFC tag and in which the processor of the UIM sends the NFC tag the corresponding payment information via the CLF device 36.

Referring now to FIG. 5, a block diagram of one example of a server, such as server 108 of FIG. 4 is provided. As shown in FIG. 5, the server generally includes a processor 94 and an associated memory 96. The memory 96 may comprise volatile and/or non-volatile memory, and may store content, data and/or the like. For example, the memory may store content, data, information, and/or the like transmitted from, and/or received by, the server. Also for example, the memory 96 may store client applications, instructions, and/or the like for the processor 94 to perform the various operations of the server in accordance with embodiments of the present invention, as described above.

In addition to the memory 96, the processor 94 may also be connected to at least one interface or other means for displaying, transmitting and/or receiving data, content, and/or the like. In this regard, the interface(s) may comprise at least one communication interface 98 or other means for transmitting and/or receiving data, content, and/or the like, as well as at least one user input interface 95. The user input interface 95, in turn, may comprise any of a number of devices allowing the entity to receive data from a user, such as a keypad, a touch display, a joystick or other input device. In this regard, the processor 94 may comprise user interface circuitry configured to control at least some functions of one or more elements of the user input interface. The processor and/or user interface circuitry of the processor may be configured to control one or more functions of one or more elements of the user interface through computer program instructions (e.g., software and/or firmware) stored on a memory accessible to the processor (e.g., volatile memory, non-volatile memory, and/or the like).

The server, for example server 108, may transmit or send an NFC application to an intermediary device, for example intermediary device 106, via a network, for example network 30 shown in FIG. 1. In one example embodiment the server may provide the NFC application to an intermediary device in response to receiving a SMS message and may send the NFC application to the intermediary device via a SMS point-to-point download. In another example embodiment, the server may download an NFC application to an intermediary device via a network (e.g., network 30) in response to the intermediary device accessing a web page associated with a URI of the server. In yet another example embodiment, the server may download an NFC application to the intermediary device via a network (e.g., network 30) according to a BIP.

It should be pointed out that FIG. 3 is a flowchart of a system, method and computer program product according to exemplary embodiments of the invention. It will be understood that each block or step of the flowchart, and combinations of blocks in the flowchart, can be implemented by various means, such as hardware, firmware, and/or a computer program product including one or more computer program instructions. For example, one or more of the procedures described above may be embodied by computer program instructions. In this regard, in an example embodiment, the computer program instructions which embody the procedures described above are stored by a memory device (e.g., memory device 76, UIM memory 52 and CLF memory 45) and executed by a processor (e.g., processor 70, UIM processor 54, CLF processor 44). As will be appreciated, any such computer program instructions may be loaded onto a computer or other programmable apparatus (e.g., hardware) to produce a machine, such that the instructions which execute on the computer or other programmable apparatus cause the functions specified in the flowchart blocks or steps to be implemented. In some embodiments, the computer program instructions are stored in a computer-readable memory that can direct a computer or other programmable apparatus to function in a particular manner, such that the instructions stored in the computer-readable memory produce an article of manufacture including instructions which implement the function specified in the flowchart blocks or steps. The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart blocks or steps.

Accordingly, blocks or steps of the flowchart support combinations of means for performing the specified functions and combinations of steps for performing the specified functions. It will also be understood that one or more blocks or steps of the flowchart, and combinations of blocks or steps in the flowchart, can be implemented by special purpose hardware-based computer systems which perform the specified functions or steps, or combinations of special purpose hardware and computer instructions.

In an exemplary embodiment, an apparatus for performing the method of FIG. 3 above may comprise a processor (e.g., the processor 70) configured to perform some or each of the operations (1-8) described above. The processor may, for example, be configured to perform the operations (1-8) by performing hardware implemented logical functions, executing stored instructions, or executing algorithms for performing each of the operations. Alternatively, the apparatus may comprise means for performing each of the operations described above. In this regard, according to an example embodiment, examples of means for performing operations (1-8) may comprise, for example, the processor 70 (e.g., as means for performing any of the operations described above), the UIM processor 54, the CLF processor 44 and/or a device or circuit for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
determining whether one or more parameters associated with at least one application are to be sent to a first device in order for the first device to execute the application;
determining whether a Single Wire Protocol (SWP) communication channel is active; and
generating a command, via a processor, to activate the SWP communication channel in response to receiving a first indication that the SWP communication channel is inactive or suspended.

2. The method of claim 1, further comprising:
determining that the first indication comprises data identifying one or more applications on a second device; and
generating an instruction indicating that the SWP communication channel is active in response to receipt of the command.

3. The method of claim 1, wherein prior to determining whether the parameters associated with the application are to be sent to the first device, the method further comprises providing the application to a second device in response to receiving a second indication that the application is available for usage.

4. The method of claim 1, further comprising determining that the parameters relate to at least one of a radio frequency (RF) technology type, read access rights, write access rights, a tunneling mode capability, a type of coding, a maximum data rate, and a maximum frame size.

5. The method of claim 2, wherein identifying comprises generating one or more identifiers that identify each of the applications, at least one of the identifiers identifies the application.

6. The method of claim 2, wherein prior to generating the instruction, the method further comprises:
deactivating the SWP communication channel in response to determining that the SWP communication channel is suspended; and
activating the SWP communication channel by causing a signal to be sent to the SWP communication channel via at least one interface.

7. The method of claim 2, wherein generating the instruction further comprises causing the instruction to be sent to the second device which generates a message comprising the parameters to be sent to the first device via the activated SWP communication channel.

8. The method of claim 7, further comprising:
reconfiguring the first device to operate in accordance with the parameters in response to receiving the message; and
executing the at least one application in response to reconfiguring the first device.

9. The method of claim 8, further comprising communicating with a third device when the first device is within a proximity of the third device and in response to the third device operating according to the parameters.

10. The method of claim 9, wherein communicating further comprises causing payment information associated with a user to be sent to the third device for payment of a transaction.

11. An apparatus comprising:
at least one processor; and
at least one memory including computer program code, the at least one memory and the computer program code configured to, with the at least one processor, cause the apparatus to perform at least the following:
determine whether one or more parameters associated with at least one application are to be sent to a first device in order for the first device to execute the application;
determine whether a Single Wire Protocol (SWP) communication channel is active; and
generate a command to activate the SWP communication channel in response to receiving a first indication that the SWP communication channel is inactive or suspended.

12. The apparatus of claim 11, wherein the computer program code is further configured to cause the apparatus to:
determine that the first indication comprises data identifying one or more applications on a second device; and
generate an instruction indicating that the SWP communication channel is active in response to receipt of the command.

13. The apparatus of claim 11, wherein prior to determining whether the parameters associated with the application are to be sent to the first device, the computer program code further causes the apparatus to provide the application to a second device in response to receiving a second indication that the application is available for usage.

14. The apparatus of claim 11, wherein the computer program code further causes the apparatus to determine that the parameters relate to at least one of a radio frequency (RF) technology type, read access rights, write access rights, a tunneling mode capability, a type of coding, a maximum data rate, and a maximum frame size.

15. The apparatus of claim 12, wherein the application comprises a near field communication (NFC) application and wherein the computer program code further causes the NFC application to exchange data between the first device and a third device when the apparatus is within a proximity of the third device.

16. The apparatus of claim 12, wherein prior to generating the instruction, the computer program code further causes the apparatus to:
deactivate the SWP communication channel in response to determining that the SWP communication channel is suspended;
activate the SWP communication channel by causing a signal to be sent to the SWP communication channel via at least one interface.

17. The apparatus of claim 12, wherein the computer program code further causes the apparatus to generate the instruction by causing the instruction to be sent to the second device which generates a message comprising the parameters to be sent to the first device via the activated SWP communication channel.

18. The apparatus of claim 17, wherein the computer program code further causes the apparatus to:
reconfigure the first device to operate in accordance with the parameters in response to receiving the message; and
execute the at least one application in response to reconfiguring the first device.

19. The apparatus of claim 18, wherein the computer program code further causes the apparatus to communicate with a third device when the first device is within a proximity of the third device and in response to the third device operating according to the parameters.

20. The apparatus of claim 19, wherein the computer program code further causes the apparatus to communicate with the third device by causing payment information associated with a user to be sent to the third device for payment of a transaction.

21. The apparatus of claim 12, wherein the apparatus comprises a mobile terminal comprising:
the first device; and
the second device, wherein the first device comprises a contactless frontend (CLF) device and the second device comprises an integrated circuit card (ICC), the CLF device is configured to communicate with a third device short range communication signals when the apparatus is within a proximity of the third device.
